(19) United States
(12) Patent Application Publication
(10) Pub. No.: US 2004/0008871 A1
(43) Pub. Date: Jan. 15, 2004

(54) Method for tactually encoding currency, currency-equivalents, and currency-surrogates for the visually-impaired

(76) Inventor: Daniel Lee Smith, Euless, TX (US)

Correspondence Address: Daniel Lee Smith, #1516, 300 E. Ash Lane, Euless, TX, 76039, US

(21) Appl. No.: 10/193,466

(22) Filed: Jul. 11, 2002

(51) Int. Cl. G06K 9/00

(52) U.S. Cl. 382/114

(57) ABSTRACT

The present invention is an improvement of currency, currency-equivalents, and currency-surrogates by the addition of tactile elements onto the face of these instruments, such that the visually-impaired can independently discern the different denominations of legal tender and negotiable instruments that are in circulation. This will end the unilateral and universal discrimination against the visually-impaired in financial affairs, and will lead to increased economic activity, financial independence, confidence, self-esteem, and additional security for the visually-impaired in their daily lives. The addition of these elements will also save the United States money in that it will make the counterfeiting of currency much more difficult and costly, and thus lead to an overall decrease in this activity worldwide.

### BACKGROUND

1. Field of Invention

This invention relates to the conversion of articles used routinely by non-disabled persons into articles that can be used by the disabled in general, and specifically to the use of currency, currency-equivalents, and currency-surrogates by the visually-impaired.

2. Description of Prior Art

Society, and governments in particular, have been striving over the years to improve the lives of disabled individuals. One avenue they have tried has been to increase the handicapped individual's participation in a world of non-handicapped persons.

In order to increase a handicapped individual's participation in a non-handicapped world, society must accommodate the particular physical requirements that each disabled person requires in order to participate to a greater degree in the life around us. We can see this attempt every day in the widened bathrooms for wheelchairs; widened entry doors; built-in ramps for the curbs, etc.

Because there are many different kinds of disabilities, a number of solutions are being implemented for various disabled group types. For example, in the previous paragraph are described several adaptations the government has mandated by law to enable wheelchair bound persons, or persons using walkers, to access public facilities.

For the hearing impaired, there is close-captioning for television; special hearing adaptor pieces for a telephone, and even flashing lights that signal when the phone or doorbell is ringing. A special visual sign language for the hearing-impaired has also been developed and adapted from native American sign language. Lip-reading classes are also given to help the hearing-impaired to communicate.

Considering all the different kinds of disabilities one might have, the one disability that is arguably perhaps the most serious or life altering, next to total quadriplegia, is that of visual impairment, and especially total blindness. A sighted person simply cannot fully appreciate the hardships and struggles the blind must endure every day. In a recent newspaper article, it was estimated that currently more than 1 million Americans age 40 or older suffer from blindness, and that in the next few decades as the boomer generation ages, that number will double.

The experts who wrote that report predict that, by 2020, 1.8 million Americans will be blind, and another 3.4 million will suffer from significant impaired vision that could threaten their way of life. As people get older, the risk of developing a number of age-related blinding diseases increases, according to the National Eye institute, part of the National Institutes of Health in Bethesda, Md.

Leading causes of vision problems and blindness, according to that report include:

Diabetic retinopathy which affects 5.3 million people today, and will affect 7.6 million people by 2020. Diabetes often causes small blood vessels in the eye to leak, which causes vision problems.

Age-related macular degeneration affects 1.6 million people today; by 2020 it will be 2.7 million persons. Macular degeneration affects the part of the eye responsible for central vision.

Cataracts affect 20.5 million people in the United States today, but that number will rise to 30 million in 2020, Cataracts are a clouding of the lens in the eye, resulting in cloudy, blurred, or obstructed vision.

Glaucoma touches 2.2 million persons in the US today, and will affect 3.4 million by 2020. Increased pressure inside of the eyeball causes slow damage to the optic nerve. Loss is so gradual many people do not know they even have this disease until it has progressed significantly.

More information on this, and other findings can be found at the National Eye Institute Web site at www.nei.nih.gov/eyedata.

For the visually-impaired, current accommodations include the recording of books, etc. on audio tape so that these persons may enjoy literature, and also take classes in school. There are audio voice programs for the computer, as well as other communications devices. There are talking glucometers for a visually-impaired person to check his or her own blood sugar if he or she is diabetic; there are even talking watches and clocks, so that these persons can know the time without asking someone.

A specific language suitable for the visually-impaired has also been developed and is known as Braille. This language functions by supplying raised tactile surfaces on flat planar surfaces which are arranged in particular groupings that can designate individual letters of the alphabet or individual numbers. A number of books and other written materials have been written in this language. Some appliances are also labeled in Braille. In FIGS. 1 and 2 the Braille system is displayed. The dots shown are small elevated bumps that are all a uniform height and size, and differ only in grouping arrangements to distinguish between different letters and numbers, as well as other symbols. FIG. 3 shows these bumps from a different perspective. A visually-impaired person trained in Braille merely has to run his fingers over the bumps to decipher words, numbers, sentences, etc. In effect, he or she is “reading” with his or her fingers.

One area that is vitally crucial in day-to-day affairs of the visually-impaired, and that has been sadly neglected, is the ability to safely and securely handle paper currency, paper currency-equivalents such as checks, money orders, certified checks, and coin-like money surrogates such as gambling chips in a casino, and bus or subway tokens.

The safe and accurate handling of metal coins is generally no problem for the visually-impaired because each different coin denomination has quite significant physical differences. This is more or less true in most countries, especially the United States. For example, coins come in different diameters. This will enable any person to tell the difference between a penny, a dime, and a quarter.

For those coins which are fairly close in diameter, such as the penney and the dime, the difference is easily ascertained, since the dime has a notched circumference. To tell the difference between a nickel and a penny, even though both are relatively close in diameter, the nickel is thicker than either the penny or the dime. To distinguish between the Susan B. Anthony dollar coin, and a quarter, which are both close in diameter and thickness, the quarter is round with a notched circumference, and the dollar coin has beveled facets around the circumference of the coin. The newer Sacagawea dollar coin, however, is a weak gold color, which only benefits the sighted person.

Thus we can see that metal coinage is already visually-impaired enabled. It is a totally different story, however, when paper currency, paper currency equivalents and the coin-like currency surrogates are discussed.

In the United States, and in many other countries as well, the paper currency notes are exactly the same size, regardless of the denomination. This is to facilitate their use in vending machines and cash registers. True, the different denominations have different printing, and even different colors—but those differences are totally useless for the visually impaired. As far as that impaired person is concerned, each piece of paper money is exactly like any other piece of paper money, or even like any piece of blank paper. To make matters worse, the paper currency in the United States is almost the same size as the paper currency of many other countries.

Thus, in this very crucial area of living, that of being able to safely and securely conduct monetary transactions, the visually-impaired person is totally dependent on someone else to help him or her do something as simply as buying a magazine. He is totally at that person's mercy, completely vulnerable; not only does the visually-impaired person have NO idea the denomination of the bill he is holding; he does not even know for sure that it is genuine money from his country, or even money at all!

If the visually-impaired person is very fortunate, he or she has a close friend or relative whom they think and pray are honest enough to mark the paper money the impaired person carries in some way, such as bending a corner, folding in half, or some other way of making each denomination somehow physically different from every other denomination so that the impaired person can conduct commerce as is necessary in every person's life, impaired or not. And if he is not lucky, then he is frequently robbed and cheated Human nature being what it is, and the size of the visually-impaired population being what it is, it is very likely that tens of thousands of dollars, if not much, much more, are annually being stolen from the visually-impaired by short changing them during monetary transactions. Since paper currency also comes in large denominations, each time a visually-impaired person dares to try to buy something, he runs a very real risk of losing large amounts of money to a dishonest merchant, as opposed to using coins, which are all small denominations for the most part. The small denomination thus limits the amount of loss per transaction, if the visually-impaired would be cheated.

Other negotiable instruments such as checks, money orders, and the like, suffer from the same terribly important shortcoming. When a visually-impaired person is handed a check, money order or the like, he or she has no idea the real amount of the instrument, or for that matter, if the piece of paper is anything but just a piece of blank paper.

It is clear, that in the area of currency, currency-equivalents and currency-surrogates, the visually-impaired are not receiving equal protection under the law compared to sighted persons. They clearly are at much higher risk for being defrauded while using the official currency of the country, than are sighted persons.

The United States Treasury has recently developed a machine for the visually-impaired that can “read” the embedded strip in currency determining the denomination. There are two major problems with this: one, only the latest bills have that strip; older bills still cannot be read. There is also some talk about counterfeiters already copying that strip into their forgeries.

Two, it still discriminates against the visually-impaired by forcing them to have a special machine in order to use money effectively and securely, that the sighted do not need to use or possess. They would need to carry this machine with them everywhere, which is very inconvenient as well as impractical. It also has not been determined if these machines will be given to the visually-impaired free of charge, or if they will have to buy them out of their own funds in order to have this convenience. This is really in contradiction to the spirit or essence of laws protecting the disabled. The laws were meant to compel the government to accommodate the needs of the disabled; the Federal Government, by forcing the visually-impaired to carry and use these machines, is actually forcing the disabled to accommodate them. This is very short-sighted, and I believe, possibly illegal.

Currency-surrogates such as gambling chips and tokens also need to be considered and encoded for the visually-impaired.

For any given casino, the chips are exactly the same size. In actuality, most game chips from all casinos, are the same size. Currently, the only way to differentiate them is by visual markings, patterns and colors. A visually-impaired person has the same right to enjoy this kind of facility with the same degree of confidence and safety as non-visually handicapped persons. Casinos, as well as other public establishments, have been required to modify entrances, exits, and restrooms for the physically disabled. To have truly equal access, one must also have equal ability to enjoy these establishments with equal safety. If the visually-impaired do not know the value of each chip they are using, then they are not being given equal access to game with equal safety, and thus are exclusively discriminated against in these establishments. Legally, they are now able to physically access the building, but still cannot visually access any of the games, the currency or currency surrogates they are using. They are allowed to play, but they are not allowed to see with what they are playing, or how much they are actually gambling. This, in essence, means the visually-impaired actually are compelled to accept much poorer gambling odds than are mandated by law for the general public.

These currency-surrogates, along with the above-mentioned currency and currency equivalents are blatantly, and terribly, discriminating against the visually-impaired. The currency-surrogates would also include tokens, which is a coin substitute, and are used in a number of venues to include subways, casinos, vending machines and the like.

The ability for every adult, and child, as well, everywhere in the world, to be able to manage his own finances, safely and efficiently conduct the most simple commercial transaction, even for a piece of gum, is, or at least, should be, the right of every citizen; all financial notes, instruments, or coins which comprise the monetary system should be able to be utilized safely, accurately, and effectively, by any person regardless of his or her physical impairments or disabilities. This is one area that urgently needs to be addressed and corrected as soon as possible in every country of the world.

Perhaps the most terrible aspect about this oversight of the government is that it could be corrected so inexpensively! It is more cost effective, and useful, to use an inexpensive method to tactually encode all currency, currency-equivalents and currency-surrogates, than to issue a special machine, which can wear out, break down, or otherwise malfunction, for all of the visually-impaired to carry around, a group which is growing in number every day. Everyone ages, and everyone becomes visually-impaired to a certain extent as he grows older. Thus any given person has a very good chance of becoming one of the significantly visually-impaired, and thus being negatively impacted by the lack of tactually-encoded currency.

Machines also break down eventually. Who can repair these money readers? How long does it take? While you are waiting for repairs are you totally without protection? Or do you just throw them away when they break, and buy a new one? Do you have to replace certain parts on occasion in order for it to read currency correctly? If you are visually-impaired, how could you see to replace those parts?

It is perhaps ironic that although the federal government guarantees a disabled person will not be discriminated against in work, they do not guarantee he will not be discriminated against in receiving payment for that work; that he can safely and effectively use the money he gets paid! By law, all businesses must pay people a fair wage for labor and in legally acceptable, and useable, tender. In essence, the federal government is fiscally discriminating against the visually-impaired by issuing the official currency in a form that only the sighted can use. The paper money now in official use only discriminates against one group of individuals: those with impaired vision, or blind. Everyone else in the world can safely use the current paper currency, even children.

Since it has not been a priority of any government to address this terrible discrimination, there is not much prior art involving changing the physical attributes of paper currency, currency equivalents, and currency-surrogates.

U.S. Pat. No. 5,636,565, Lawrance, et al., June 1997 speaks to the problem, albeit in a very limited way in his “Embossing method and device for braille currency encoding.” In this patent he suggests embossing each denomination of a bill with the corresponding braille code for that amount of money. For example, a ten-dollar ($10.00) bill in US currency would be embossed in braille with the coding that represents the number “10” somewhere on the bill surface that was easily detected by those who are proficient in that tactile language. Although embossing has been used successfully on other kinds of paper documents, such as the raised seal of a notary public, these documents are not intended to undergo the wear and tear of currency in circulation, and are not intended to befell by everyone who sees it, in order to decipher it. This is an admirable attempt at correcting this critical problem, but there are several things wrong with this particular approach.

First, the braille system employs a series of raised “bumps” on a planar surface, such as seen in a piece of paper. By arranging the “bumps” in certain configurations, words, sentences, numbers, etc., can be formed, but they can only be deciphered by a person who is proficient in this system, which is a very specialized language.

There are any number of ways to deploy elevations or “bumps” on a planar surface in order to effect the braille code. Embossing is merely one of these ways. Unfortunately, unless special precautions are taken, this would be unsuitable for currency purposes. Embossing means simply pushing, under pressure, any given design, number, symbol, etc., against a planar surface of a suitably pliable substance, such as paper, with enough force to deform the plane of paper, causing elevations and depressions on that plane which physically corresponds in shape and size to the die or stamp that is causing the deformation. Thus, embossing braille characters or symbols on paper currency would cause the little bumps that characterize that system. Unfortunately, the bumps, using the embossing method, would be hollow. Being hollow and of such small size, as is normally the case with these kind of characters, and as shown in the figures on this particular patent, it would only be a very short period of time before those hollow bumps are flattened back down to the same level as the rest of the piece of the paper, thus effectively preventing any imprinted braille character from being felt by the finger tips. Currency is subject to significant wear and tear over the life of the bill, and it would seem that the simple embossing of a number or character in braille would be ineffective and a waste of money and time, as it would virtually disappear on each note in probably just a few days or weeks at the most. The United States Treasury department actually considered making this change, under direction from Congress, but decided against it for the apparent lack of durability, and thus, longevity. Additionally, even though there is a significant visually-impaired and blind segment of society, of these, only a very small percentage know, and can actually effectively use, braille.

Additionally, without special treatment of the paper involved to strengthen it, and care taken as to the exact height of the “bumps,” trying to emboss these characters might actually involve some of those characters punching all the way through the bill, just producing holes, and something that is indecipherable to a braille reader.

Another very important consideration would be the effect of a currency note suitably altered by the elevations of braille characters, on a public vending machine or ATM. These kinds of machines are notorious for the kinds of bills they will accept. A note has to be in almost perfect condition, with no folds, wrinkles, etc., in order to work at all. It is questionable whether braille-altered bills would even work, mandating either a prohibitively expensive retooling of those machines, a collapse of vending commerce completely, or the removal of those altered bills from circulation. Thus the system as envisioned in this patent, on the face, would appear not to be very durable, possibly non-functioning for vending commerce, and thus not suitable for a national currency.

Perhaps the most limiting aspect of utilizing the braille system, is related to the few number, percentage-wise, of people who can actually read braille The term “visually-impaired” encompasses so many kinds of people other than just totally blind. A large number of these persons are the elderly who, although not totally blind, are legally blind because their vision is so poor as to be almost useless. Some can see with very strong reading glasses, or a magnifying lens, if held right up in front of their face; some can only differentiate light from dark; some see furry dark indistinct shapes; and others not at all. Since our nation is demographically growing in population AND age, the total number of persons who will fall into the visually-impaired category cannot fail to dramatically increase as the years go by. Therefore, there is even more reason to address this issue as soon as possible, and, in fact, is long overdue.

In U.S. Pat. No. 6,083,270 Scott July 2000, is disclosed a type of electronic device which could be built that could decipher various kinds of input and give back various kinds of output for use in electronic machines, such as computers, ATMS, microwaves, etc. This does not address currency, however, and would be an added expense for every disabled individual in order to procure one. Additionally, it would take training for that individual to be able to fully utilize it, as well as possible electronic adaptors for every device desired to be on that system. Also, as was mentioned previously, machines ultimately fail some day. For the visually-handicapped, it would also again use braille, with all of the disadvantages inherent in that system as mentioned previously.

In U.S. Pat. No. 5,702,559 Bright December 1997, a method is disclosed for applying tactile sensible indicia such as glue droplets onto a label, or embossing, or marking with glue droplets to mark various articles for the visually-impaired. Again, the critical item of currency is not mentioned, and, again, the labeling would only use braille characters, with all of the disadvantages inherent in that system as previously mentioned.

In U.S. Pat. No. 5,251,758, Kolacek, October 1993, a food container with a portion having sense of touch indicia, is disclosed. The system would use pliable material which could be molded into tactile elements to label containers. The tactile elements would again be braille, with all of the disadvantages inherent in that system, as mentioned previously. This patent also does not suggest nor mention the possibility of applying this to paper currency.

The U.S. Pat. No. 4,307,266, Messina, December 1981 discloses a communication apparatus for the disabled, specifically the visually-impaired. It does not include currency as is in the present invention, and also uses braille as the labels; this again suffers from the disadvantages and limitations of that system as mentioned previously.

In U.S. Pat 6,059,575, Murphy, May 2000, a tactile recognition input device and overlay for use with an input device are disclosed. This would be used primarily with devices such as a computer keyboard. It again does not apply to currency, and again, uses the braille characters, with all of the inherent disadvantages and limitations of that system as mentioned previously.

The U.S. Pat. No. D308,668, Briscoe, et. al, a data communications panel for the deaf and/or deaf-blind persons is disclosed. It again does not address itself to currency, and again, it utilizes braille characters as tactile elements, with all of the inherent disadvantages and limitations of that system as previously mentioned.

In U.S. Pat. No. 4,119,809, Bianchini, October 1978, is disclosed a braille lens for telephone dials. This once more, does not address itself to the critical area of currency identification, and, additionally, utilizes braille characters with all of the inherent disadvantages and limitations of that system as noted previously.

In U.S. Pat. No. 4,679,342, Wilson, July 1987, a means for rendering controls tactually-sensitive is disclosed. This patent pertains to microwave ovens, washing machines and the like, and does not apply to currency, which is a totally different field.

In the Japanese patent, JP000047792, February 2000, Moritaka, et. al, is disclosed a device for presenting braille information through tactile sensation. Once again, it does not apply to currency, and is utilizing the braille system, with all of its inherent disadvantages and limitations as previously mentioned.

In the European patent, EP0962909, Ri Su Hong, December 1999, a braille label writer is disclosed. This also is not addressed to the labeling of currency, and also uses the braille system with all of its inherent disadvantages and limitations, as previously discussed.

In the France patent, FR2777505, Patrick, October 1999, is disclosed the braille encoding of identification cards, so that the visually-impaired can tell with whom they are communicating to prevent fraud. This would not prevent fraud, as anyone could have an ID card imprinted falsely with false braille information. Additionally, it does not address itself toward the identification of currency, and also uses the braille system, with all of its inherent disadvantages and limitations as discussed previously.

In the Great Britain patent, GB2332172, Darrin, June 1999 is disclosed a braille overlay sleeve for a mobile telephone keypad. This, once more, does not address itself toward the identification of currency for the visually-impaired, and again, utilizes the braille system, with its inherent disadvantages and limitations.

In the Japanese patent, JP10307664, Hiroshi, November 1998, is disclosed a keyboard cover with braille characters. This does not address itself toward the identification of currency, and also utilizes the braille system with its inherent disadvantages and limitations, as mentioned previously, and also below.

Blindness comes from so many causes and at so many different ages, the percentage of persons blind from birth is a very small fraction of all visually-impaired persons. The elderly were previously mentioned, and this is a very sizeable percentage. Most of them are simply unable, whether through patience or mental agility, to learn the braille system. Other groups would include those with damaged eyesight due to trauma, and those with diminishing eyesight related to the development of glaucoma, diabetes, and other diseases.

Another significant limiting factor to the usefulness of braille, is that it is not universally known in this country, let alone the other countries of the world. A universally recognized system for the visually-impaired to use to physically distinguish different denominations of currency should be able to be used everywhere in the world, or at least the vast majority of places.

Finally, braille characters do not resemble, in shape, any known number or letter. Learning braille does not enable you to write in any recognizable sighted language. Even the visually-impaired must sign their name from time to time on legal documents, so they must learn two languages; their own native language, so that they can write in it, and braille, so they can read in it.

Clearly, there must be some way to alter the tactile surface of paper money, money equivalents, and money surrogates, such that the different denominations can easily be determined, and the system can be used on virtually any currency in any country. It must also be inexpensive, and compatible with electronic vending or ATM machines, worldwide. Ideally, it should be able to be deciphered by both impaired and non-impaired persons.

Because of the way languages developed through history, there are certain characters, which are used almost everywhere in the world, and in most cases, especially the numerals, mean exactly the same in every country. These are sometimes referred to as “arabic” characters and numbers. For example, the symbol the United States uses for the number ten, which is “10”, means ten units of something. In every other country when you see that number, it also means ten units of something, although the word in their language which symbolizes the number 10 is spelled and pronounced differently in different countries. For example, the word in English which spells the number “10” is spelled, “TEN”; the word that signifies the number “10” in Spanish is: “DIEZ.” As one can see, although the term is spelled differently, it still uses the same numerical and alphabetical characters as are found in the above universal alphabet set. In the United States, a ten-dollar bill would say “10 Dollars”; in Italy, a currency note worth ten Liras would say, “110 Lira.” Even though ten dollars is not equal to ten liras in monetary exchange rates, that is not important. What is important is that the numeric symbol “10” means ten units of that currency no matter on which currency the term is found. Thus, that imprinted or otherwise deployed symbol on currency means “ten” units everywhere. The numbers and letters which are mentioned later in this paper feature familiar sets of characters which are, for most practical and business reasons in the world, universal. It should also be noted that there are great numbers of visually-impaired persons in all countries of the world which use our currency, thus any improvements which are added to our currency will also benefit those persons, as well. It will not take special training by anyone, since almost everyone can feel these characters, and know what they mean, since they are the same characters as their native language. Even those persons who learned braille can easily decipher them.

Additionally, whether for good or for bad, the English language is rapidly becoming the “universal” language of business, and since business involves currency, letters and numbers that appear on most currencies will be understandable to most people in the world. It is also noted that United States paper currency is widely used in almost every country of the world, and, just like the English language, is becoming the “universal” business currency used almost in every country.

The Treasury Department of the United States, in a document entitled, “The Use and Counterfeiting of United States Currency Abroad,” dated January 2000, estimates that approximately 60-75 percent of all United States currency is being held overseas for various reasons. The total value is estimated at between $250 billion to $350 billion. Some countries, such as Panama, have actually adopted the United States currency as their own. Argentina has announced that it may also give up its own currency to adopt that of the United States. Large quantities of banknotes are being exported to numerous countries on a daily basis.

This, as well as the proposed addition of tactile characters to currency, are also factors that will affect, and decrease, the widespread criminal activity of counterfeiting United States currency.

The counterfeiting of United States currency is a problem that is growing daily all over the globe. With the advent of inexpensive, very good computers, scanners, and printers, the ability to counterfeit passable copies is becoming easier. The United States Treasury estimates that anywhere between 25 million and 150 million dollars are counterfeited each year in various countries of the world. Any physical, tactile change made to currency that cannot be duplicated by a color printer will greatly decrease the amount of counterfeiting in all areas. See Tables 1 and 2 which have been reproduced from “The Use and Counterfeiting of United States Currency Abroad”; a report to the Congress by the Secretary of the Treasury, dated January 2000.

As can be seen by these tables, a significant problem exists concerning the counterfeiting of United States currency. Since the currency from the United States is in such high demand in almost every other country, for various reasons, the printing technology available to the general public is improving, and is readily and inexpensively available, this problem will continue to grow unless other measures are taken in the design of the currency that will make the simple computer-generated printing of it impractical and ineffective

TABLE 1
Top Ten Countries in Counterfeits Seized, Fiscal Years 1996-98

Dollars

| | | |
|---|---|---|
| Economy | Seized | Passed |

FY 1998

| | | |
|---|---|---|
| 1. Italy | 37,614,330 | 21,560 |
| 2. United States | 29,942,874 | 39,954,290 |
| 3. South Africa | 16,743,200 | 10,050 |
| 4. Germany | 4,574,600 | 89,280 |
| 5. Turkey | 3,700,300 | 4,015 |
| 6. Colombia | 3,444,460 | 6,846 |
| 7. Taiwan | 1,800,000 | 50 |
| 8. France | 1,500,000 | 19,920 |
| 9. Canada | 1,255,400 | 14,701 |
| 10. Dominican Rep. | 1,203,400 | 41,350 |

FY 1997

| | | |
|---|---|---|
| 1. United States | 40,385,661 | 31,750,859 |
| 2. Pakistan | 11,859,100 | 450 |
| 3. Italy | 10,693,720 | 33,990 |
| 4. England | 8,734,000 | 407,505 |
| 5. Argentina | 4,307,950 | 43,160 |
| 6. Colombia | 3,799,110 | 10,310 |
| 7. Germany | 2,805,300 | 77,860 |
| 8. Portugal | 2,472,100 | 8,600 |
| 9. South Africa | 2,155,500 | 900 |
| 10. Mexico | 2,002,520 | 186,810 |

FY 1996

| | | |
|---|---|---|
| 1. United States | 63,691,115 | 29,831,108 |
| 2. Colombia | 36,87,1730 | 10,650 |
| 3. Italy | 19,759,540 | 2,308,800 |
| 4. Germany | 19,041,830 | 523,630 |
| 5. Yugoslavia | 5,863,300 | 320 |
| 6. England | 5,218,430 | 104,035 |
| 7. Greece | 2,772,900 | 2,670 |
| 8. France | 2,407,800 | 59,800 |
| 9. Canada | 2,127,480 | 32,150 |
| 10. Sweden | 2,066,000 | 300 |

TABLE 2
International Counterfeiting Statistics for Fiscal Year 1998,
Ranked by Total Dollar Value of Counterfeits Reported

Dollars

| Economy | Passed | Seized | Total |
|---|---|---|---|
| Italy | 21,650 | 37,592,680 | 37,614,330 |
| South Africa | 10,050 | 16,743,200 | 16,753,250 |
| Germany | 89,280 | 4,574,600 | 4,663,880 |
| Turkey | 4,015 | 3,700,300 | 3,704,315 |
| Colombia | 6,846 | 3,444,460 | 3,451,306 |
| Taiwan | 50 | 1,800,000 | 1,800,050 |
| France | 19,920 | 1,500,200 | 1,520,120 |
| England | 280,360 | 1,061,900 | 1,342,269 |
| Canada | 14,101 | 1,255,400 | 1,270,101 |
| Dominican Republic | 41,350 | 1,203,400 | 1,244,750 |
| Finland | 2,700 | 1,092,500 | 1,095,200 |
| Thailand | 6,770 | 631,260 | 638,030 |
| Azerbaijan | 200 | 597,500 | 597,500 |
| Poland | 6,770 | 521,000 | 527,770 |
| Egypt | 20,220 | 451,520 | 471,740 |
| Panama | 72,990 | 373,000 | 445,990 |
| Namibia | 21,350 | 364,020 | 385,370 |
| Greece | 300 | 377,200 | 377,500 |
| Netherlands | 166,040 | 195,170 | 361,210 |
| Belarus | 300 | 325,800 | 326,100 |
| The Gambia | 0 | 250,100 | 250,100 |
| Mexico | 208,850 | 2,885 | 211,735 |
| Georgia | 0 | 200,000 | 200,000 |
| Hong Kong | 192,235 | 6,200 | 198,435 |
| Kyrgyzstan | 0 | 192,300 | 192,300 |
| United Arab Emirates | 184,900 | 0 | 184,900 |
| Switzerland | 171,191 | 12,300 | 183,491 |
| Argentina | 18,950 | 152,500 | 171,450 |
| Israel | 12,450 | 140,200 | 152,650 |
| Monaco | 144,500 | 200 | 144,700 |
| Malawi | 139,590 | 0 | 139,590 |
| Spain | 44,310 | 76,350 | 120,660 |
| Albania | 101,620 | 16,900 | 118,520 |
| Austria | 71,215 | 41,750 | 112,965 |
| Venezuela | 3,280 | 100,900 | 104,180 |
| Total outside the | 3,113,775 | 79,665,935 | 82,779,710 |
| United States: | | | |
| Memo: Total inside the | 39,954,290 | 29,942,874 | 69,897,164 |
| United States | | | |

The addition of a tactile surface, of which there are several methods discussed below, to aid the visually-impaired will also make it much more difficult to counterfeit, since a normal computer printer cannot also produce the raised, textured or otherwise altered surface.

Probably the most inexpensive and most easily done, would be to use an embossing method to at least emboss one numeral of the currency in a prominent place. A very elaborate engraving could be used for the embossing die, which would be artistically agreeable, as well as difficult for counterfeiters to reproduce. As the current plates for currency need replacing, this embossing could be built into any new plate, thus reducing the cost of implementing the new design by eliminating the need of building a new embossing die to emboss existing bills.

It is to address these issues that the present invention is presented.

The present invention will incorporate into or onto currency, currency-equivalents and currency-surrogates, symbols, letters and numbers that are tactile elements which can be distinguished from the surface of the note, and will convey information to the visually-impaired, such as the denomination of the note. These tactile elements can be discerned solely through the use of touch. There are a number of ways to augment the tactile discernability of the elements.

This invention will employ familiar symbols that can be understood by millions of people in the world, impaired and non-impaired, in an elevated, depressed, or textured manner, on the surface of paper currency, currency-equivalents, and currency-surrogates. These are the same graphic symbols that are currently used by most of the world. In the western world, it is known as the “western” alphabet, numbers, and other symbols, namely:

1) Letters of the alphabet, the physical shapes of: “A”, “B”, “C”, “D”, “E”, “F”, “G”, “H”, “I”, “J”, “K”, “L”, “M”, “N”, “O”, “P”, “Q”, “R”, “S”, “T”, “T”, “U”, “V”, “W”, “X”, “Y”, “Z”, the upper and lower case of those letters, various combinations of those letters to represent differences in word, spelling, and phonetic structures of all the various languages of the world.

2) The numeric characters are: “0”, “1”, “2”, “3”, “4”, “5”, “6”, “7”, “8”, “9”

3) The special characters which are well known and utilized differently in different countries, but are found on most computer keyboards: “#”, “@”, “&”, “%”, “$”, “\hat{ }”, “*”, “<”, “>”, “?” (Or inverted), as well as other various markings and punctuation used in various countries are included.

The tactile elements may be elevated above, or depressed below, the plane of the currency involved, sufficient in height to be easily distinguishable by the use of one's fingers. The sense of touch is very sensitive, and it is probable that the characters need not be elevated or depressed more than 1/64 of an inch, and probably even less. There are a number of ways to cause a tactile element to be elevated above, or depressed below, the surface of the paper; some of which have already been discussed, and others will be mentioned.

Alternatively, instead of deploying elevated or depressed tactile elements, by changing the texture of the surface of the tactile characters to something different from the surface texture of the bill itself will aid in the ability to interpret the character, and thus reduce, or eliminate the elevation used for the character. This is, in effect, changing the coefficient of friction for the involved character, from the coefficient of friction of the note itself.

The coefficient of friction is merely a number that relates to how smooth or rough a surface is. It also depends on what kind of material from which the object is made, and if it is polished, rough, lubricated., etc. The higher the coefficient of friction, the rougher the surface. The lower the value, the smoother the surface. By changing the smoothness of the character deployed on the note, relative to the smoothness of the note itself, a discernible character can be easily elicited. The exact value for the different coefficients of friction is not important; what is important is the degree of relative difference between that of the character placed on the currency, and that of the surface of the currency, currency-equivalent, or currency-surrogate. Typical values range from 0.01 for smooth surfaces, to 1.5 for rough surfaces. This is a unit-less number, since it is a ratio of the magnitudes of two different forces; that of the character itself, and that of the surface of your finger. By running a finger over the character, kinetic friction will make the surface feel either rougher, or smoother, than that of the paper itself, to your finger.

For example, if you deployed a recognizable character on the surface of the bill that had a fine-grained sandpaper feel, even if it is not elevated significantly, the rough texture would easily be able to be discerned and the shape of the character determined just by the sense of touch, thus identifying the denomination of the note. Conversely, if the surface of the character was smoother than that of the bill itself, such as a thin overlay of plastic or metal, it would still be discernible. All that is required is a difference in texture, whether smoother or rougher, than the bill itself, and that of your finger.

Depending on the substance used for the texture, the elevation or depression could be minimal, or even almost nonexistent providing the tactile texture difference between the surface of the paper, and the surface of the character deployed which depicts the denomination, is significantly different. Since the sense of touch is so sensitive, it will not take much of a difference in smoothness, or roughness, to make a significant difference that can be discerned.

And still yet another alternative method to deploy tactile elements instead of using elevated or depressed tactile figures or shapes, would be to construct the tactile elements or figures out of materials that differ significantly in thermal conductivity to that of the paper in the bill itself, to aid in distinguishing currency denominations. Different materials have differing abilities to conduct heat, thus feel different when touched by fingers. For example, a paper-thin overlay of metal depicting the denomination of the bill would feel either significantly cooler, or significantly warmer, depending on the ambient air temperature, than the surface of the bill, which is made of paper, since paper does not conduct temperature as well as metal, and thus make identification of the bill by tactile means possible. In fact, paper is more of a thermal insulator than a thermal conductor.

Thermal conductivity is measured in joules per second per meter per Celsius degrees. Some examples of different values for common materials are as follows:

| | [J/(s · m · C. degrees)] |
|---|---|
| METALS | |
| Aluminum | 240 |
| Brass | 110 |
| Copper | 390 |
| Iron | 79 |
| Lead | 35 |
| Silver | 420 |
| Steel (stainless) | 14 |
| OTHER | |
| MATERIALS | |
| Asbestos | 0.090 |
| Body fat | 0.20 |
| Concrete | 1.1 |
| Diamond | 2450 |
| Glass | 0.80 |
| Goose down | 0.025 |
| Styrofoam | 0.010 |
| Water | 0.60 |
| Wood (oak) | 0.15 |
| Wool | 0.040 |

As can be seen, there are a wide variety of values. Metals have high values, as would be expected, and they make very good thermal conductors. Place your hand on a pizza pan that is just out of the oven, and this is obvious.

Conversely, the smaller the value for any given material the less of a thermal conductor it is, and the more of a thermal insulator it is. For example, goose down, with a value of 0.025 conducts heat poorly, but is a very good insulator. It is for this reason that comforters and sleeping bags are made from this material. It keeps in heat, but does not transmit or carry it.

Thus, the currency itself, being made from paper and rags, would have a very low value; wood from which paper is made, is 0.15. One would only need to find a material with a significantly higher value, such as a metal, for example, to cast the monetary value characters in, and the difference between the characters and the note would be easily distinguished using the sense of touch.

The numerical characters formed from a higher thermal conducting material could be adhered to the surface of the note using any number of suitable organic adhesives such as are already found abundantly in industry. There are many types of adhesives which will adhere two different types of material to each other, such as wood to glass, metal to plastic, glass to metal, paper to wood, etc. The adhesive would be stronger than the shear strength of the paper note, and thus would be permanent, lasting the life of the bill itself. The characters could be thinner than the thickness of the paper and still be easily discerned from the different temperature feel, compared to the paper. The exact composition of the adhesive would be, of course, a state secret, and could be also manipulated to make counterfeiting more easily detectable, and more difficult to accomplish. Almost all facets of money production are top secret, such as the exact composition of the paper, the rag content, what the colored fibers are composed of, etc. and thus the final composition of any element is strictly left to the government's discretion.

Additionally, the surface of the metal or plastic or other material, could be highly polished, a lower coefficient of friction; or highly granulated, which is a higher coefficient of friction, adding a difference in texture to the figure, as well as the temperature difference. The character representing the denomination would ideally be approximately the same size as are currently printed in the corners of any bill, thus, would not hinder the ability to fold the currency either horizontally, or vertically, as is sometimes done in the course of daily affairs for various reasons. Also, if a material such as plastic or metal is used, the character would be more durable than the paper itself, and thus last as long as the paper does, until that bill is pulled from circulation for wear. These thinner-than-paper overlays, by their low profile, would also present no problem to vending machines. They could, as well, contain other inclusions that can be detected radiographically, visually, or by other means, that would make counterfeiting much more difficult. The very addition of the characters themselves will make counterfeiting much more difficult and expensive. The cost of the addition of these characters will more than be compensated for from the savings in one year from the reduction of counterfeits. Each additional year of savings yields that much more bonus and savings for the United States.

Regarding elevated tactile elements, there are any number of ways to cause characters to be elevated from a given plane.

One way is to emboss a character or tactile element. This involves the use of a die or template, upon which is the desired character. The die is then forcibly pressed into the paper or surface, which will cause the paper to display the character that was on the die, just as a notary public embosses a document with a seal.

Previously, a patent to emboss braille characters was discussed. Since the braille characters are composed of small “bumps,” those bumps have a high probability of not remaining embossed, by being crushed down and flattened during the life of the bill.

The current invention involves the use of tactile elements, letters, symbols, numbers and the like, which if elevated, or depressed, are much larger in size than the mentioned braille bumps, and thus much less likely, and more difficult, to be flattened. This is demonstrated by the durability of notary republic seals on paper. These embossed symbols last for years and years on regular paper. Additionally, other measures can be taken to enhance the durability of the elevated or depressed characters. For example, chemical surface sealants could be sprayed upon the embossed character to give it strength, such as starch compounds, or plastic polymers.

Another way to strengthen the embossed characters would be to change the composition of the bill itself to maximize the durability of the embossed characters. The addition of more rag content, the addition of plastic threads or polymers, or even the addition of fiberglass could yield the desired durability. If the paper money is then hot stamped with an embossing plate, the added plastic or polymers would melt within the paper, conforming to the shape of the embossing die, and then when the die is removed, the plastic or polymers would cool, retaining the shape embossed upon them. These added elements would also make the bill much harder to counterfeit. Credit cards have embossed numbers on them, and they are virtually indestructible.

The embossing could be of just one numeral depicting the denomination of the bill, of two numerals; all four numerals on all corners; a spelled-out denomination, or any combination of the above.

For example, for a one dollar bill you would have a “1” or “ONE” embossed; for a five-dollar bill you would have a “5” or a “FIVE” embossed on it. You could have embossing on one plane, that is, up from the main surface, or you could emboss in two directions, up from the main surface of the bill, and down from the surface of the bill. This would make counterfeiting much more difficult as well as making the note more easily distinguishable to the visually-impaired. Or, another method would be to emboss the first letter of the denomination somewhere on the bill, in an easily detectable size. For example, a ten-dollar bill would have a large “T” embossed on it. A five-dollar bill would have a large “F”; a hundred an “H,” and a one dollar bill an “O.” These could be located anywhere, from a corner, to being along an edge, or even right in the center of the bill, embossed over the engraved picture of the president.

Still another way to deploy raised or elevated tactile characters on the bill would be to stamp out appropriately-sized plastic characters, then using a strong adhesive, apply them to the bill. These characters could either be clear, opaque, colored, or even have colored threads going through them. A printed ribbon with the denomination could also be embedded within the plastic characters. All of these things would, again, help prevent counterfeiting of the bill, since it would make it much more difficult and costly to do so. The characters could be hollow, which would allow some compression, or solid-filled to allow for increased durability. Even hollow embossed plastic characters, such as are seen on credit cards, would have basically permanent durability (for the life of the note). The characters themselves, being basically the same size as the characters currently found on currency, would be large enough to be easily discernible, without having to have them elevated very far above the surface of the plane of the currency. The elevation of 1/64″, or even less, would be easily felt, and thus, discernible among different face values of bills. This very slight elevation would also not interfere with mechanical, automated vending machines. As long as the elevation is kept to a minimum, these characters could either be the same size as the printed characters on the note, or even significantly larger, to make tactual detection easier.

Still another way to deploy raised characters on the bill would be to spray a strong adhesive in the shape of the character desired onto the appropriate place of the bill, and then spraying again with a textured particle, such as finely ground sand, plastic, rubber, rock, paper or other material. That material would stick to the adhesive on the bill, causing a raised surface thus making the character desired. It would be a very thin layer, yet since it has a quite different feel to it, having a higher coefficient of friction than the regular surface of the bill, as well as a different thermal conductivity than the paper, thus the character could easily be interpreted. The adhesive would be stronger than the paper itself, allowing for a good length of wear.

Another way to have elevated characters on the bill would be to emboss characters out of a thin plastic sheet that has a strong pressure sensitive adhesive on the back. Then you could separate individual characters, or overlays, and stick them onto the bill. The characters could then be “read” by someone's fingers. These could also be made of clear plastic or some other kind of polymer, rubber, or come in colors, or combinations of colors and clear spaces, and also contain inclusions in the plastic, if desired by the government, as a further counterfeiting deterrent. These plastic overlays could be put on in a temporary manner, or in a permanent manner if desired. If a permanent attachment is desired, a suitably strong adhesive, with a stronger attachment strength, than the shear or tear strength of the bill, would be employed. If a temporary use, a weak adhesive, such as used on plastic adhesive tape, would be used.

Still another simple way to cause elevated characters would be to apply successive layers of thick ink, or other suitable liquid, in the form of a desired character. The number of coats would determine the height of the elevated character, and could be elevated as much, or as little as needed. Also, the number of coats would determine the durability or survival length of the character. Alternatively, it would also be feasible to “paint” on layers, or using paint-type materials that will dry, and also be tactually distinguishable over the material of the currency on which it is deployed. The inks currently used on paper money are very durable, and could conceivably serve this purpose, if deployed in numerous layers, to build up thickness.

And yet another simple method to deploy elevated characters, would be to spray a plastic, resin, rubber, or other compound right onto the bill surface in the shape desired to depict the denomination of the bill. Rubber compounds, especially, have great durability and can have a great variety of textured surfaces with minimal elevation of the character above the plane of the paper bill. For example, a rubbery compound known as “chemi-gum” was used in the sole of a shoe that was popular during the 1970's known as a desert boot or chukka boot. This material was extremely durable and easily outlasted the leather uppers of the shoe. A similar material could easily be applied in a very thin layer, as thin as, or thinner than, the paper itself, to depict a denomination of a currency that would be very durable, easily distinguished from the paper surface, and have any given textured surface desired to aid in counterfeiting deterrence. It also has a significantly different thermal conductivity than the paper itself, giving the visually-impaired an additional tool in distinguishing different currency denominations. Virtually any material could be used, including powdered wood, or stone, or any other substance other than the main construction material of the currency involved.

In all of the above-mentioned ways, the characters could be solidly elevated, depressed, embossed or texturized the whole length of the character, or have intermittent deployment in any shape or size that form the outline of the desired character. All that is required is that whatever method is used, a normal person with a normal sense of touch, can discern the appropriate character by oily using touch.

The elevated, depressed, embossed, texturized or overlay character could be designed for decorative or counterfeit deterrent purposes, as well, to satisfy other areas of concern. It can be as elaborate, or as simple, as desired. Once the initial molds or tools are designed, having a more elaborate design really does not add significantly more to the cost per note, than a simple design, yet would greatly enhance the visual appearance of the note to those with sight, and also make it that much more difficult to counterfeit.

### SUMMARY

In accordance with the present invention, a method to encode currency, currency-equivalents and currency-surrogates is presented, with tactile elements or surfaces that can distinguish one denomination from another for the visually-impaired.

### OBJECTS AND ADVANTAGES

Accordingly, some of the objects and advantages of the present invention are:

(a) to enable the visually-impaired to be easily able to distinguish different denominations of paper currency;

(b) to enable the visually-impaired to be easily able to distinguish different denominations of money-equivalents, such as money orders, certified checks, etc.;

(c) to enable the visually-impaired to be more independent in financial, commercial, business and personal dealings;

(d) to enable the visually-impaired to distinguish local currency from foreign currency;

(e) to prevent the visually-impaired from being short-changed or defrauded by dishonest persons;

(f) to enable the visually-impaired to easily determine the appropriate denomination of currency needed by any given vending machine or ATM and thus enabling them to use these machines which are used daily by non visually-impaired persons;

(g) to prevent the embarrassment of the visually-impaired from using an inappropriate denomination of currency for any given transaction;

(h) to help the visually-impaired lead a more productive and independent life;

(i) to help the visually-impaired have more self-esteem from the increased financial independence;

(j) to help the visually-impaired have more self-esteem from the greatly-decreased dependence on other parties for even the most basic financial transaction;

(k) to help establish a universal tactile system for all of the world's currencies that the visually-impaired in any country can use safely;

(l) to visually enhance the appearance of currency for the non-visually impaired;

(m) to make currency much more difficult and costly to counterfeit;

(n) to eliminate the financial discrimination that currently exists for the visually-impaired;

(o) to increase the volume, amounts, and variety of commercial transactions participated in by the visually-impaired, due to:

1 increased ease;

2. increased security;

3. increased accuracy;

4. decreased fraud perpetrated against the vision-impaired;

5. increase in self-worth and esteem due to increased independence;

and thus increase the general economic activity for the country in question by an increase in all of the economic activities of the visually-impaired;

(p) greatly increase the quality of life for the vision-impaired;

(q) to enable the visually-impaired, by touch, to distinguish the different denominations of currency surrogates such as gaming chips for use in casinos, or tokens that are used in subways, bus systems, pay toilets, etc.

(r) to improve the lives of the visually-impaired the world over, due to the vast circulation and use of United States currency worldwide;

(s) to stop the terrible, and singular, discrimination by the Federal Government, and other businesses against the visually-impaired regarding the handling of money, and money substitutes;

(t) to grant the visually-impaired their right to equal protection under the law, as it applies to monetary and fiscal concerns, as guaranteed by the Constitution of the United States, as well as other legal statutes.

Further objects and advantages include pressuring governmental agencies to mandate tactile surfaces which can identify different denominations on all forms of currency, currency-equivalents, and currency surrogates to end the pointless, destructive, pervasive, and illegal financial discrimination which exists worldwide against the visually-impaired, and disabled individuals in general. Still further objects and advantages will become apparent from a consideration of the ensuing description and drawings.

### DRAWING FIGURES

In the drawings, closely related figures have the same number.

FIGS. 1 and 2 show the braille characters that are used by the blind.

FIG. 3 shows the alphanumeric characters that will be used to tactually encode currency, currency-equivalents and currency-surrogates.

FIG. 4 shows a mockup of a US ten-dollar bill, with the numeric symbol for “10” given a tactually-discernible surface.

FIG. 5 shows another US ten-dollar bill, with both tactile numerals for the number “10”, and a tactile three letter code for the country.

FIG. 6 shows another US bill, this time with both a tactile “10” in numerals, and the tactile spelling for the word, ten.

FIG. 7 shows a tactile code for the country, “USA”, running vertically instead of horizontally, as well as a tactile “10” in numerals.

FIG. 8 shows a tactile USA code across the engraving in the center of the bill.

FIG. 9 shows a tactile spelling “TEN” across the engraving in the center of the bill.

FIG. 10 shows a gaming chip, with a tactile element in the center of the chip.

FIG. 11 shows a 3D graphic showing how the raised or tactile element would visually appear of the word “TEN”.

FIG. 12 shows a 3d graphic representation how the raised or tactile element would visually appear of the word “USA”.

FIG. 13 shows how any given alphanumeric tactile character could be formed using different patterns, such that they basically outline the character. FIG. 13a shows a solid character; FIG. 13b shows a character outlined in tactile dots; FIG. 13c shows a tactile dot character with attached tactile lines; FIG. 13d shows a character outlined by using the symbol for a star. The symbol used could be anything, as long as it forms the outline for the character intended.

### REFERENCE NUMERALS IN DRAWINGS

10 the tactile elements showing the numeral “10” for denomination of the bill

12 a tactile three letter code for a country of origin of the bill

14 the tactile characters spelling out the number “TEN”

15 tactile elements spelling out a denomination on a gaming chip

16 the tactile braille elements representing the number “TEN”

18 a tactile three letter code for a country, incorporated into the engraving in the middle of the bill

20 the tactile spelling of the bill denomination incorporated into the engraving in the middle of the bill

22 the center panel of a gaming chip

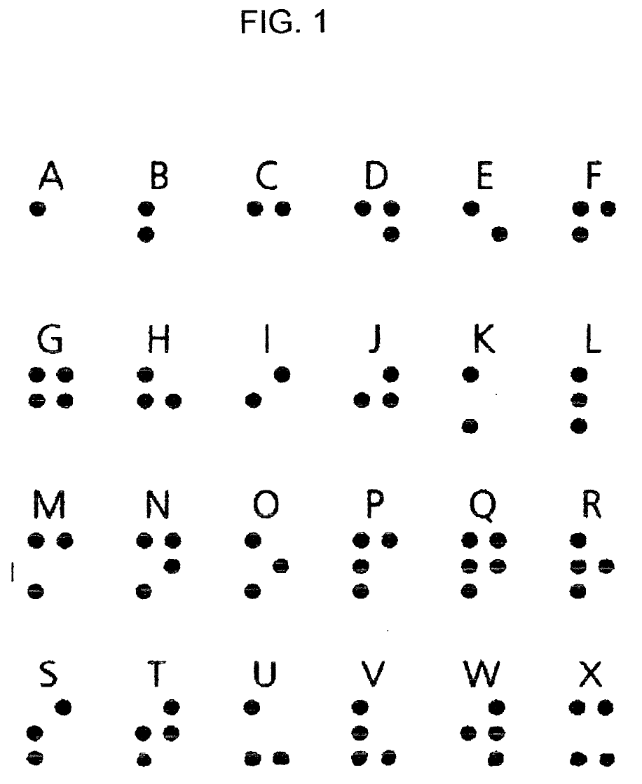

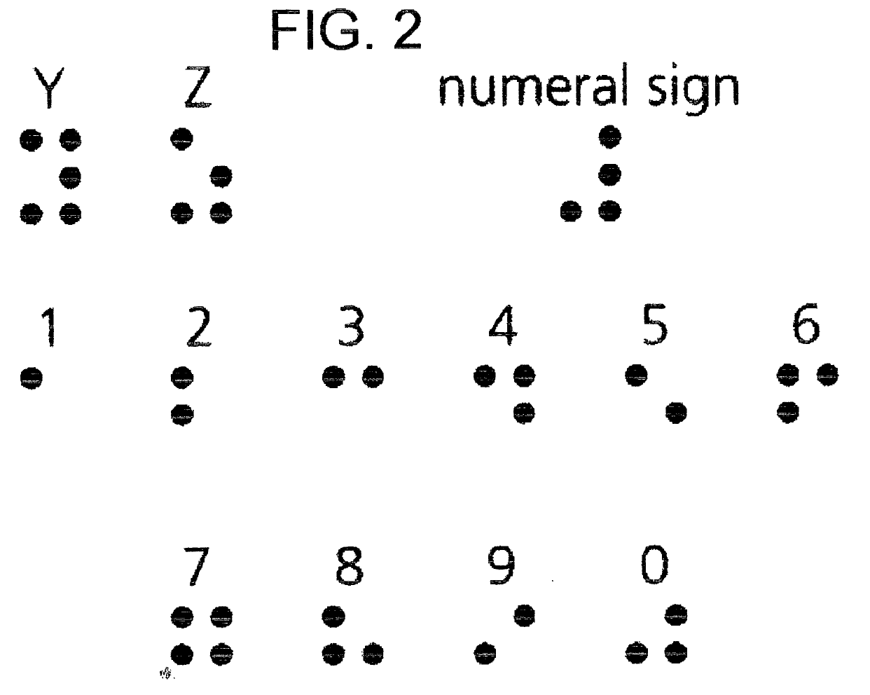

In FIGS. 1 and 2 are displayed the Braille characters that are being used as a tactile language for the blind.

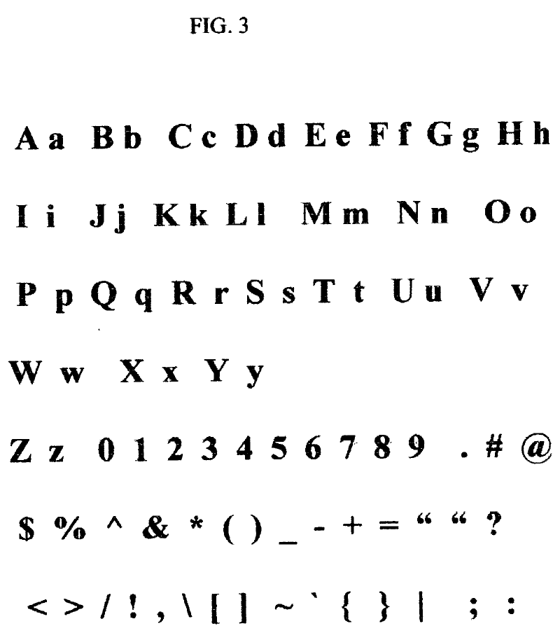

FIG. 3 is the set of characters that could be used on a piece of currency, currency-equivalent, or currency-surrogate. These are the common characters found in all languages of Romance or Germanic descent.

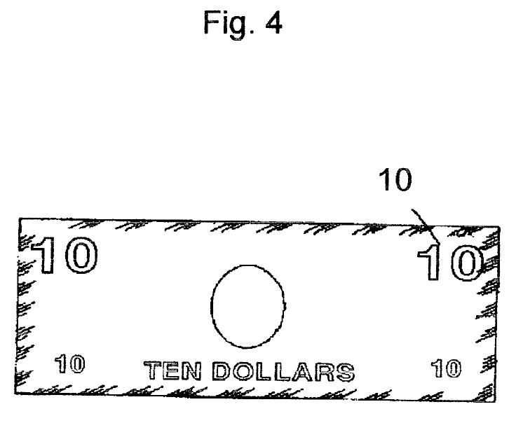

FIG. 4 shows a mockup of a typical US ten-dollar bill. #10 is the numeric symbol of ten, the denomination of the bill. In the preferred embodiment of this invention, both of the larger “10”s on the top of the bill would be elevated above the surface of the bill, or textured, so they could be easily felt.

If cost is a factor, only one of them need be elevated or textured. As long as one number 10 symbol is rendered as tactile, the denomination of the bill could be determined. For other denominations the same could be done; elevate or texturize at least one of the numbers depicting the denomination of the bill.

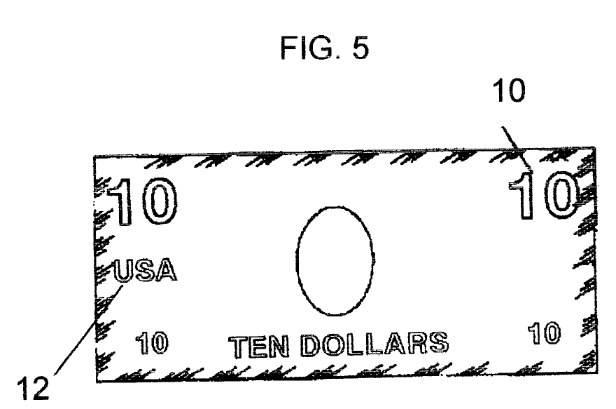

FIG. 5 shows another embodiment of the invention. #10 is the tactile numeral for the denomination of the bill. #12 is a three-letter code depicting the country of the bill for the visually-impaired. When other countries start producing currency that has tactile surfaces, a code will be necessary to differentiate between them. The three letter code would also be a tactile element. Alternatively, a code with any desired number of letters could be used. Some suggested three letter codes for other countries are:

GER—Germany

AUS—Australia

EUR—Eurodollars

SSR—Countries of the former Soviet Republic

GBR—Great Britain and territories

CAN—Canada

PER—Peru

COL—Columbia

MEX—Mexico

JAP—Japan

ICE—Iceland

GRE—Greenland

BRA—Brazil

CHI—China

SIN—Singapore

MAL—Malaysia

GUA—Guatemala

Other three letter codes will be adopted by other countries as they follow suit and produce currency that can aid the visually-impaired.

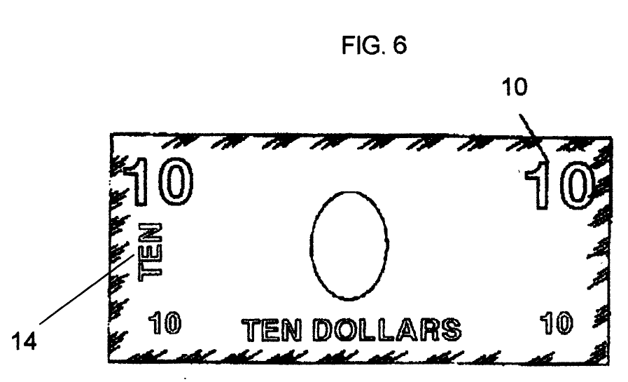

FIG. 6 shows yet another embodiment of this invention. #10 is again the tactile number ten. #14 is a tactile spelling of the number 10, so that there are both a tactile number symbol, and the tactile spelling for that symbol, as an additional confirmation of the denomination of the bill. The spelled out denomination can be located anywhere on the bill. This would apply similarly to any denomination of currency, currency-equivalent, or currency-surrogate.

And yet another embodiment of the present invention would have the tactile spelled out denomination on the currency, currency-equivalent, or currency-surrogate.

Another embodiment of the present invention would deploy a tactile element on any given bill with an arbitrary symbol or geometric design which represents that particular denomination. For example, a star shape could represent a ten-dollar bill; a solid circle could represent a one dollar bill; a triangle could represent a twenty-dollar bill, and so forth. This would apply to currency, currency-equivalents or currency-surrogates.

Still another embodiment of the present invention would deploy a tactile element that is either one or more letters that symbolize the denomination of the bill. For instance, an “H” located in a prominent place on the bill could symbolize a hundred-dollar bill. A “T” tactile element could symbolize a ten-dollar bill. An “O” element could signify a one-dollar bill. A “TW” could represent a twenty-dollar bill. An “F” element could signify a five-dollar bill. This could be utilized on currency, currency-equivalents or currency-surrogates.

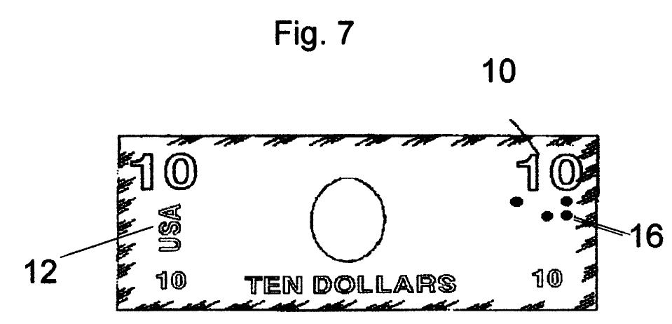

And yet another embodiment of the present invention in FIG. 7, #12 shows the tactile USA code running vertically, instead of horizontally as shown in FIG. 5. Again, the tactile “10” is shown by #10, and the braille code for “10” is shown by #16. This would be employed on other denominations as well of currency, currency-equivalents or currency-surrogates.

And still another embodiment of the present invention would have a tactile denomination numeral and also the braille code for the tactile numeral on currency, currency-equivalents, or currency-surrogates.

And yet another embodiment of the present invention would have two or more tactile denomination numerals and the braille code for the tactile numeral on currency, currency-equivalents or currency-surrogates.

And yet another embodiment of the invention would have a tactile denomination numeral, the denomination spelled out in a tactile manner, and the braille code for the tactile numeral on currency, currency-equivalents or currency-surrogates.

And yet another embodiment of the bill would have multiple tactile denomination numerals, the denomination spelled out in a tactile manner, and the braille code for the tactile numeral on currency, currency-equivalents or currency-surrogates.

Still, another embodiment of the bill would have multiple tactile denomination numerals on currency, currency-equivalents or currency-surrogates.

Another embodiment of the present invention would have multiple tactile denomination numerals, and the denomination spelled out in a tactile manner on currency, currency-equivalents or currency-surrogates.

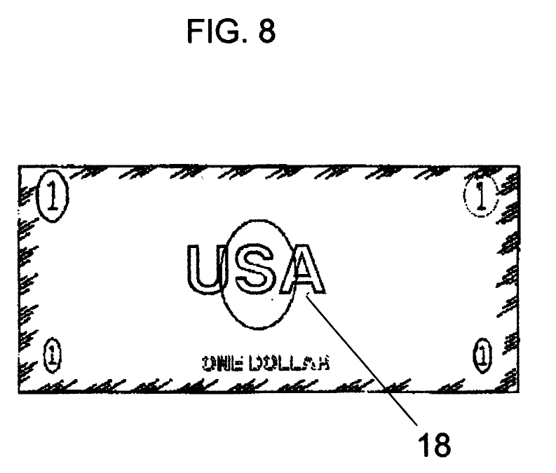

Still, another embodiment of the present invention is seen in FIG. 8. #18 shows a tactile “USA” code behind the photo of the president, as would be seen in all denominations of United States currency.

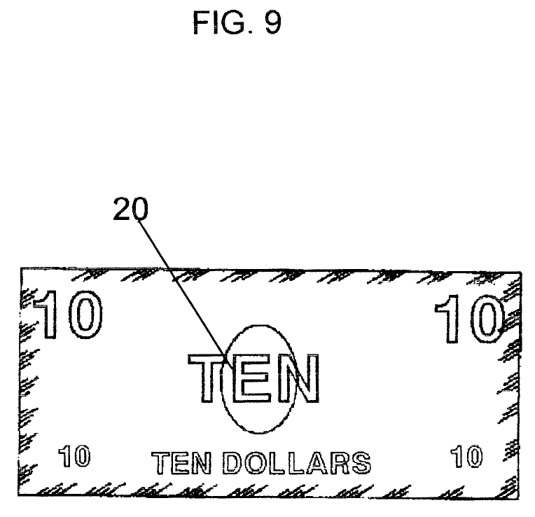

And yet another embodiment of the present invention is seen in FIG. 9. #20 is a tactile spelling of the bill denomination “10” for a ten-dollar bill behind the portrait of the president, and similarly for other denominations of currency.

In yet another embodiment of the present invention, there would be a tactile spelling of the bill denomination behind the president's engraving, and there would also be a tactile number of the bill's denomination in the upper corner of the currency, currency-equivalent or currency-surrogate.

In still another embodiment of the present invention, there would be multiple tactile numerals depicting the denomination, the denomination spelled out in a tactile manner, and tactile letters, numbers, symbols or any combination of those that symbolize the code for the country of origin on the currency, currency-equivalent, or currency-surrogate.

Another embodiment of the present invention would include multiple tactile numerals depicting the denomination, the denomination spelled out in a tactile manner, tactile letters, numbers, symbols, or any combination of those that symbolize the code for the country of origin, and the braille code for that denomination on the currency, currency-equivalent, or currency-surrogate.

Another embodiment of the present invention would include one tactile numeral depicting the denomination, the denomination spelled out in a tactile manner, tactile letters, numbers, symbols, or any combination of those that symbolize the code for the country of origin, and the braille code for that denomination on the currency, currency-equivalent, or currency-surrogate.

And yet another embodiment of the present invention would have a sprayed, applied, painted, or inked on texture that spells out the denomination of the currency, currency-equivalent, or currency-surrogate, the numerals representing the denomination, and the letter code that depicts the country of origin.

Another embodiment of the present invention would have a sprayed, applied, painted, or inked on texture that only outlines the numerals of the denomination involved on the currency, currency-equivalent or currency-surrogate.

Another embodiment of the present invention would have a sprayed, applied, painted, or inked on texture that spells out the denomination of the currency, currency-equivalent or currency-surrogate in letters.

Another embodiment of the present invention would have a sprayed, applied, painted, or inked on texture that spells out the country of origin, and the denomination of the currency, currency-equivalent or currency-surrogate.

And still another embodiment of the present invention would have an elevated number depicting the denomination of the currency, currency-equivalent or currency-surrogate, and have a sprayed, applied, painted, or inked on texture on the surface of the elevated number.

In still another embodiment of the present invention, a plastic sheet overlay with a pressure-sensitive adhesive back, would have embossed or tactually depicted on it detachable numbers and letters with which to adhere to any given currency, currency-equivalent or currency-surrogate in order to label it for the visually-impaired.

In yet another embodiment of the present invention, a plastic sheet overlay with a pressure-sensitive back, would have on it sprayed, applied, painted or inked letters and numbers which could be detached and applied to the surface of any given currency, currency-equivalent, or currency-surrogate in order to label it for the visually-impaired.

In still another embodiment of the present invention, a portable embossing tool would have a die with all of the above-mentioned characters on it, in order to emboss, and thus label, any currency, currency-equivalent, or currency-surrogate for the visually-impaired.

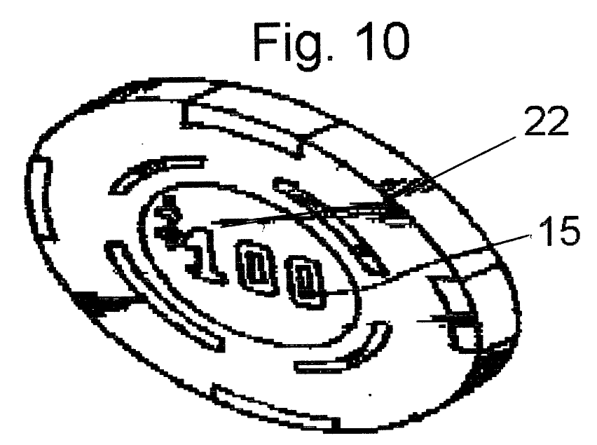

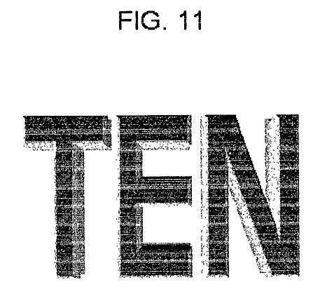

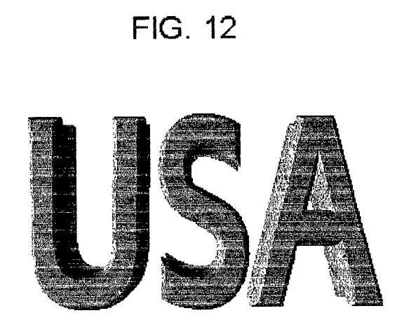

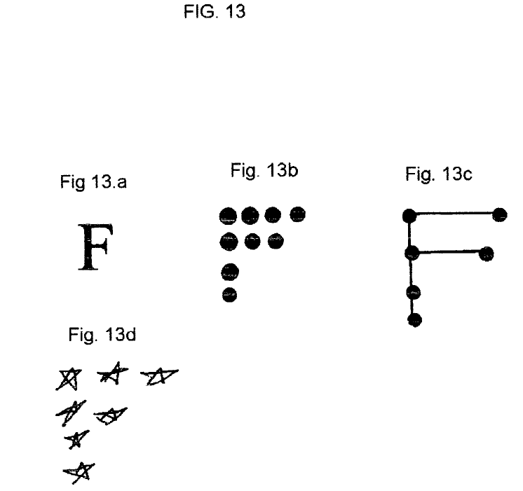

In still another embodiment of the present invention, in FIG. 10, is illustrated a currency-surrogate, a typical gaming chip. The center chip panel is #22, upon which is the tactile numeric denomination, #15, that can be felt with the fingertips, thus enabling a visually-impaired person to be able to tell the denomination of the gaming chip.

In another embodiment of the present invention, the denomination of the currency-surrogate would have a sprayed, applied, painted or inked on texture to enable the visually-impaired to differentiate the different denominations of gaming chips, tokens, or other currency-surrogate.

In another embodiment of the present invention, a tactile number depicting the amount of the currency equivalent, such as check or money order, will be deployed in either a temporary or permanent manner in a conspicuous place on the note, in order for the visually-impaired to independently determine the amount of the currency-equivalent in question.

In still another embodiment of the present invention, a currency-equivalent such as money-order or check, will have sprayed, applied, painted, or inked on texture that depicts the value of the given currency equivalent so that a visually-impaired person can independently determine the proper amount as is written on that currency-equivalent.

### CONCLUSION, RAMIFICATIONS, AND SCOPE

Accordingly, the reader will see that by tactually-encoding currency, currency-equivalents and currency-surrogates, the visually-impaired will be able to independently participate in financial transactions with the same efficiency, safety and security as sighted persons. Additionally, the deployment of tactile elements to currency, currency-equivalents and currency-surrogates has the additional advantages in that

it makes currency, currency-equivalents and currency-surrogates more difficult to counterfeit;

improves the general economy secondary to the reduced amount of counterfeit currency, currency-equivalents and currency-surrogates;

adds visually interesting elements to currency, currency-equivalents and currency-surrogates;

aids the visually-impaired in every country that uses United States currency;

increases the amount of economic activity by the visually-impaired;

improves the economy by virtue of the increased economic activity;

decreases the number of visually-impaired on government assistance by providing for secure, verifiable, usable wages;

improves the lives of the visually-impaired, by allowing them greater participation in business or commerce;

improves the lives of the visually-impaired by decreasing the amount of fraud perpetrated against them;

improves the self-esteem of the visually-impaired by enabling them to be more independent;

allows the visually-impaired to participate more fully and safely in recreational activities such as gambling;

permits the visually-impaired to safely utilize vending machines and ATMS;

decreases the amount of time and trouble family members must spend on their visually-impaired members, thus freeing up that time for other activities;

enables the visually-impaired to verify independently the wages they are paid;

enables the visually-impaired to verify independently the amount of money they are spending;

enables the visually-impaired to verify independently the amount of money they receive as change in commercial transactions;

ends the financial and fiscal discrimination for the visually-impaired.

Although the descriptions above contain many specificities, these should not be construed as limiting the scope of the invention but as merely providing illustrations of some of the presently preferred embodiments of this invention. For example, elevated or textured overlays could be applied to phones, cell phones, other communication devices; appliances, computer keyboards, restaurant menus, advertising, etc. This is one invention that really needs to be implemented as soon as possible. It is cost effective, and is simply the right thing to do for all of us.

1) A method for tactually-encoding currency, currency-equivalents and currency-surrogates comprising;
a. providing a piece of legal tender in the form of currency, currency-equivalents and currency-surrogates,
b. providing a set of characters that will be understood by persons using said piece of currency, currency-equivalents and currency-surrogates, and
c. providing a tactile means to deploy said set of characters onto said piece of currency, currency-equivalents, and currency-surrogates,
whereby said set of characters will be deployed on said piece of currency, currency-equivalents and currency-surrogates in a tactile manner, using a tactile means;
whereby said currency, currency-equivalents and money-surrogates will have its denomination tactually discernible by using said set of characters;
whereby a person can use touch alone to ascertain said denomination of said currency, currency-equivalents and currency-surrogates by tactually-discerning said set of characters deployed by said tactile means.

2. The method for tactually-encoding currency, currency-equivalents, and currency-surrogates of claim 1, wherein, said set of characters includes: A, a, B, b, C, c, D, d, E, e, F, f, G, g, H, h, I, i, J, j, K, k, L, l, M, m, N, n, O, o, P, p, Q, q, R, r, S, s, T, t, U, u, V, v, W, w, X, x, Y, y, Z, z, 0, 1, 2, 3, 4, 5, 6, 7, 8, 9, !, @,#,$, %, \hat{ }, &, *, (,), _, −, +, ?, \, /, >, <, :, ;, “, “, ‘, ‘, ., .

3. The method for tactually-encoding currency, currency-equivalents, and currency-surrogates of claim 1, wherein said currency comprises the paper money or legal tender, of all the countries of the world, particularly the United States of America.

4. The method for tactually-encoding currency, currency-equivalents, and currency-surrogates of claim 1, wherein said currency-equivalents include money orders, checks, savings bonds, certified checks and all other negotiable instruments.

5. The method for tactually-encoding currency, currency-equivalents, and currency-surrogates of claim 1, wherein, said currency-surrogates include gaming chips, tokens and any other coin-like object, used in a commercial transaction the same way coins are used.

6. The method for tactually-encoding currency, currency-equivalents, and currency-surrogates of claim 1, wherein, said tactile means to deploy said set of characters is selected from the group consisting of embossing, layering of ink, plastic overlays, metal overlays, paper overlays, sprayed on textures, painted on textures, the application of characters with a different thermal conductivity than that of the main construction material of said currency, said currency equivalents and said currency-surrogates, and characters with a different coefficient of friction than the main material of said currency, currency-equivalents and currency-surrogates.

7. A method to enable the visually-impaired to determine the different denominations of currency, currency-equivalents, and currency-surrogates comprising:
a. providing a piece of legal tender in the form of currency, currency-equivalents and currency surrogates,
b. providing an incorporating means to deploy a tactile texture or surface onto said currency, currency-equivalents and currency-surrogates;
c. providing a character set containing numbers, letters, and symbols from which said tactile texture or surface is designed and deployed such that they spell out or otherwise depict different denominations;
whereby said currency, currency-equivalents and currency surrogates on which is deployed a tactile texture or surface in the shape of characters, symbols, numbers and letters from said character set;
whereby said characters, symbols, numbers and letters from said character set depict or spell out different denominations of said currency, currency-equivalents and currency surrogates;
whereby the visually-impaired will be able to independently determine the correct value of said currency, currency-equivalents and currency-surrogates utilizing only the sense of touch to discern said tactile texture or surface in the shape of said characters, symbols, numbers and letters from said character set.

8. The method to enable the visually-impaired of claim 7, wherein said means to deploy a tactile texture or surface include applied, sprayed, inked, painted, embossed and stamped characters;

9. The method to enable the visually-impaired of claim 7, wherein said tactile surface includes any material which has a different coefficient of friction than that of the main construction material of said currency, currency-equivalents and currency-surrogates.

10. The method to enable the visually-impaired of claim 7, wherein, said character set includes the characters: A, a, B, b, C, c, D, d, E, e, F, f, G, g, H, h, i, J, j, K, k, L, l, M, m, N, n, O, o, P, p, Q, q, R, r, S, s, T, t, U, u, V, V, W, w, X, x, Y, y, Z, z, 1, 2, 3, 4, 5, 6, 7, 8, 9, 0, $, &, *, \hat{ }, %, @, #, and the comma (,) and the period (.).

11. The method to enable the visually-impaired in claim 7, wherein, said tactile texture or surface includes any material which has a different thermal conductivity than the main construction material of said currency, said currency-equivalent and said currency-surrogate.

12. A tactually-encoded piece of currency consisting of:
a) a piece of currency which is legal tender;
b) a set of characters which are understood by the user of said piece of currency, and which can be used to differentiate different values of currency,
c) a means to tactually deploy said set of characters on said piece of currency, so that the value of the piece can be discerned solely through the sense of touch,
whereby a visually-impaired person, solely by using the sense of touch, can discern the value of said piece of currency,
whereby said visually-impaired person can more effectively and easily engage in commercial transactions, and
whereby said visually-impaired person is less likely to be cheated by a sighted-person, since said visually-impaired person will now know definitively the value of each piece of currency he uses in every transaction, and will know the definitive value of each piece of currency he receives back as change.
